(19) United States
(12) Patent Application Publication
(10) Pub. No.: US 2006/0120432 A1
(43) Pub. Date: Jun. 8, 2006

(54) Tympanic thermometer with ejection mechanism

(76) Inventors: Loren Lantz, Charles, MO (US); James Harr, Foristell, MO (US)

Correspondence Address: Tyco Healthcare Group LP;Attention: Intl. Property Dept. Docketing Clerk, 15 Hampshire Street, Mansfield, MA, 02048, US

(21) Appl. No.: 10/538,543

(22) PCT Filed: Jan. 6, 2003
(86) PCT No.: PCT/US03/00256

§ 371 Date: Jun. 10, 2005

(51) Int. Cl. G01J 5/00; G01K 1/08; G01K 1/00

(52) U.S. Cl. 374/208; 374/121; 374/158

(57) ABSTRACT

A tympanic thermometer is provided including a heat sensing probe that defines a longitudinal axis and an outer surface extending from a distal end of the tympanic thermometer. An ejection apparatus including at least one finger extends from the distal end of the tympanic thermometer and is configured for movement along the outer surface of the probe. A probe cover is mountable to the distal end of the tympanic thermometer. The probe cover defines an inner surface configured to engage the outer surface of the probe. The probe cover includes at least one longitudinal rib radially projecting from the inner surface thereof. The longitudinal rib defines a proximal face such that the at least one finger is configured to engage the proximal face. The probe cover can include a plurality of longitudinal ribs.

### CROSS-REFERENCE TO RELATED APPLICATIONS

This patent application incorporates by reference PCT Application No. PCT/US03/______. Express Mail Label No. EV222416147US, filed in the U.S. Patent and Trademark Office on Jan. 6, 2003, the entire contents of which is hereby incorporated by reference herein.

### BACKGROUND

1. Technical Field

The present disclosure generally relates to the field of biomedical thermometers, and more particularly, to a tympanic thermometer that employs an ejection apparatus and a probe cover to improve accuracy of temperature measurement and safety.

2. Description of the Related Art

Medical thermometers are typically employed to facilitate the prevention, diagnosis and treatment of diseases, body ailments, etc. for humans and other animals, as is known. Doctors, nurses, parents, care providers, etc. utilize thermometers to measure a subject's body temperature for detecting a fever, monitoring the subject's body temperature, etc. An accurate reading of a subject's body temperature is required for effective use and should be taken from the internal or core temperature of a subject's body. Several thermometer devices are known for measuring a subject's body temperature, such as, for example, glass, electronic, ear (tympanic).

Glass thermometers, however, are very slow in making measurements, typically requiring several minutes to determine body temperature. This can result in discomfort to the subject, and may be very troublesome when taking the temperature of a small child or an invalid. Further, glass thermometers are susceptible to error and are typically accurate only to within a degree.

Electronic thermometers minimize measurement time and improve accuracy over glass thermometers. Electronic thermometers, however, still require approximately thirty (30) seconds before an accurate reading can be taken and may cause discomfort in placement as the device must be inserted into the subject's mouth, rectum or axilla.

Tympanic thermometers are generally considered by the medical community to be superior for taking a subject's temperature. Tympanic thermometers provide rapid and accurate readings of core temperature, overcoming the disadvantages associated with other types of thermometers. Tympanic thermometers measure temperature by sensing infrared emissions from the tympanic membrane (eardrum) in the external ear canal. The temperature of the tympanic membrane corresponds to the core temperature of a subject's body. Further, measuring temperature in this manner only requires a few seconds.

Known tympanic thermometers typically include a probe containing a heat sensor such as a thermopile, a pyroelectric heat sensor, etc. See, for example, U.S. Pat. Nos. 6,179,785, 6,186,959, and 5,820,264. These types of heat sensors are particularly sensitive to the eardrum's radiant heat energy.

In operation, a tympanic thermometer is prepared for use and a probe cover is mounted onto a sensing probe extending from a distal portion of the thermometer. The probe covers are hygienic to provide a sanitary barrier and are disposable after use. A practitioner or other care provider inserts a portion of the probe having the probe cover mounted thereon within a subject's outer ear canal to sense the infrared emissions from the tympanic membrane. The infrared light emitted from the tympanic membrane passes through a window of the probe cover and is directed to the sensing probe by a waveguide. The window is typically a transparent portion of the probe cover and has a wavelength in the far infrared range. The probe cover should provide for the easy and comfortable insertion of the probe into the ear canal.

The practitioner presses a button or similar device to cause the thermometer to take a temperature measurement. The microelectronics process electrical signals provided by the heat sensor to determine eardrum temperature and render a temperature measurement in a few seconds or less. The probe is removed from the ear canal and the probe cover is removed and discarded.

Proper removal of a used probe cover from the probe is necessary for accurate temperature measurements of subsequent readings using the tympanic thermometer. Proper removal of the used probe cover is also required for safety to the subject such that disease propagation is minimized. Current tympanic thermometers may employ mechanisms and probe covers that are not properly removed in an efficient and facile manner. These types of tympanic thermometer designs can adversely affect the accuracy and safety considerations of a temperature reading.

For example, a used probe cover may contain undesirable material, for example, moisture, ear wax, etc., from within the ear of a subject, which may contaminate the probe cover. Attempted removal of the probe cover may cause disease or other infections or tearing of the probe cover such that a portion of the probe cover remains with the probe.

Other known tympanic thermometer devices include ejection devices that eject the probe cover after use. See, for example, U.S. Pat. No. 5,411,032. Similar devices, however, engage a circumferential flange adjacent a base of the probe cover. A drawback of these designs is that moisture buildup, flange configuration, etc. of the probe cover may cause the ejection device to slip over the flange, or strike the flange causing the body of the probe cover to fracture due to the relative weakness of the probe cover body compared to the force used to strike the base flange. Consequently, the probe cover remains attached to the probe, or tears such that a portion of the probe remains with the probe.

In the event that a used probe cover or a portion thereof remains with the probe cover, the probe cannot accurately sense infrared emissions. Further, the risk for disease propagation from one subject to another is dangerously increased.

Therefore, it would be desirable to overcome the disadvantages and drawbacks of the prior art with a tympanic thermometer that employs an ejection (hands-free) apparatus and a probe cover to improve temperature measurement accuracy and safety to minimize disease propagation. It would be desirable if such a tympanic thermometer included an engagement surface within a probe cover of the tympanic thermometer to achieve the principles of the present disclosure. It would be highly desirable if the probe cover included a longitudinal rib with the engagement surface to provide strength and stability to the probe cover. It is contemplated that the tympanic thermometer and its constituent parts is easily and efficiently manufactured and assembled.

### SUMMARY

Accordingly, a tympanic thermometer is provided that employs an ejection apparatus and a probe cover to improve temperature measurement accuracy and safety to minimize disease propagation to overcome the disadvantages and drawbacks of the prior art. Desirably, it would be desirable if such a tympanic thermometer included an engagement surface within a probe cover of the tympanic thermometer to achieve the principles of the present disclosure. The tympanic thermometer is easily and efficiently manufactured and assembled. The present disclosure resolves related disadvantages and drawbacks experienced in the art.

The engagement surface of the tympanic thermometer disclosed herein can facilitate accurate and safe temperature measurement by providing a strike interface between an ejection apparatus and a probe cover thereof. The strike interface provides several advantages including ejection of the probe cover from a heating sensing probe after use. This may be accomplished by depressing an ejection button or the like of the tympanic thermometer.

Another advantage of the strike interface is providing an indication that a used probe cover is removed and that a new unused probe cover is in position and ready for temperature measurement. This can be accomplished via triggering circuitry that senses a presence of a probe cover and correspondingly indicates to a practitioner that the tympanic is ready for use. Accordingly, such triggered circuitry may indicate that the tympanic thermometer is not ready for use until a new, unused probe cover is mounted to the heat sensing probe. It is envisioned that the probe cover can be particularly configured for employment with the tympanic thermometer, in accordance with the principles of the present disclosure.

In one particular embodiment, in accordance with the principles of the present disclosure, a tympanic thermometer is provided including a heat sensing probe that defines a longitudinal axis and an outer surface extending from a distal end of the tympanic thermometer. An ejection apparatus including at least one finger extends from the distal end of the tympanic thermometer and is configured for movement along the outer surface of the probe. A probe cover is mountable to the distal end of the tympanic thermometer. The probe cover defines an inner surface configured to engage the outer surface of the probe. The probe cover includes at least one longitudinal rib radially projecting from the inner surface thereof. The longitudinal rib defines a proximal face such that the at least one finger is configured to engage the proximal face. The probe cover can include a plurality of longitudinal ribs.

The outer surface of the probe may define a groove. The groove is transversely oriented relative to the longitudinal axis and is configured to receive a portion of the probe cover for releasably retaining the probe cover with the probe. The portion of the probe cover includes a plurality of protuberances projecting from the inner surface of the probe cover and is proximally spaced from the distal end of the probe cover. The transverse groove may be disposed circumferentially about the outer surface of the probe and substantially perpendicular to the longitudinal axis of the probe.

The ejection apparatus may include a plurality of fingers. The at least one finger can include a tapered finger tip defining a distal strike face. The at least one finger may be movable between a retracted position and an extended position. The at least one finger may be biased to the extended position. The at least one finger may also be releasably fixable in a retracted position. Alternatively, the at least one finger is releasably fixable via a latch, whereby the latch includes a release button that is engageable to release the at least one finger from the retracted position.

The at least one longitudinal rib may have a transverse face having a substantially parallel orientation relative to the longitudinal axis of the probe.

In an alternate embodiment, the ejection apparatus includes equidistantly spaced fingers. The fingers having a tapered finger tip that defines a distal strike face and the probe cover including equidistantly spaced longitudinal ribs. The longitudinal ribs having a proximal strike face, wherein the distal strike face and proximal strike face engage for moving the fingers between a retracted position and an extended position.

### BRIEF DESCRIPTION OF THE DRAWINGS

The objects and features of the present disclosure, which are believed to be novel, are set forth with particularity in the appended claims. The present disclosure, both as to its, organization and manner of operation, together with further objectives and advantages, may be best understood by reference to the following description, taken in connection with the accompanying drawings wherein:

FIG. 1 is a perspective view of a tympanic thermometer, in accordance with the principles of the present disclosure, mounted with a holder;

FIG. 2 is a perspective view of the tympanic thermometer shown in FIG. 1;

FIG. 3 is a side cross-sectional view of a distal end of the tympanic thermometer shown in FIG. 2, in part elevation;

FIG. 4 is an enlarged perspective view of the indicated area of detail shown in FIG. 3;

FIG. 5 is an enlarged perspective view of the indicated area of detail shown in FIG. 3;

FIG. 6 is a cross-section of a probe cover mounted to the tympanic thermometer shown in FIG. 2, in perspective;

FIG. 7 is an enlarged perspective view of the indicated area of detail shown in FIG. 6;

FIG. 8 is an enlarged perspective view of the distal end of the tympanic thermometer shown in FIG. 2, having parts removed to illustrate an ejection apparatus;

FIG. 9 is a side cross-sectional view of the distal end shown in FIG. 3, illustrating ejection of the probe cover; and

FIG. 10 is an enlarged perspective view of the distal end shown in FIG. 8, illustrating ejection of the probe cover.

### DETAILED DESCRIPTION OF EXEMPLARY EMBODIMENTS

The exemplary embodiments of the tympanic thermometer and methods of use disclosed are discussed in terms of medical thermometers for measuring body temperature, and more particularly, in terms of a tympanic thermometer that employs an ejection apparatus and a probe cover to improve temperature measurement accuracy and safety to minimize disease, bacteria, etc. propagation. It is envisioned that the present disclosure finds application for the prevention, diagnosis and treatment of diseases, body ailments, etc. of a subject. It is further envisioned that the principles relating to the tympanic thermometer disclosed include proper removal of a used probe cover via the ejection apparatus and indication to a practitioner whether a new, unused probe is mounted to the tympanic thermometer.

In the discussion that follows, the term “proximal” will refer to the portion of a structure that is closer to a practitioner, while the term “distal” will refer to the portion that is further from the practitioner. As used herein, the term “subject” refers to a human patient or other animal having its body temperature measured. According to the present disclosure, the term “practitioner” refers to a doctor, nurse, parent or other care provider utilizing a tympanic thermometer to measure a subject's body temperature, and may include support personnel.

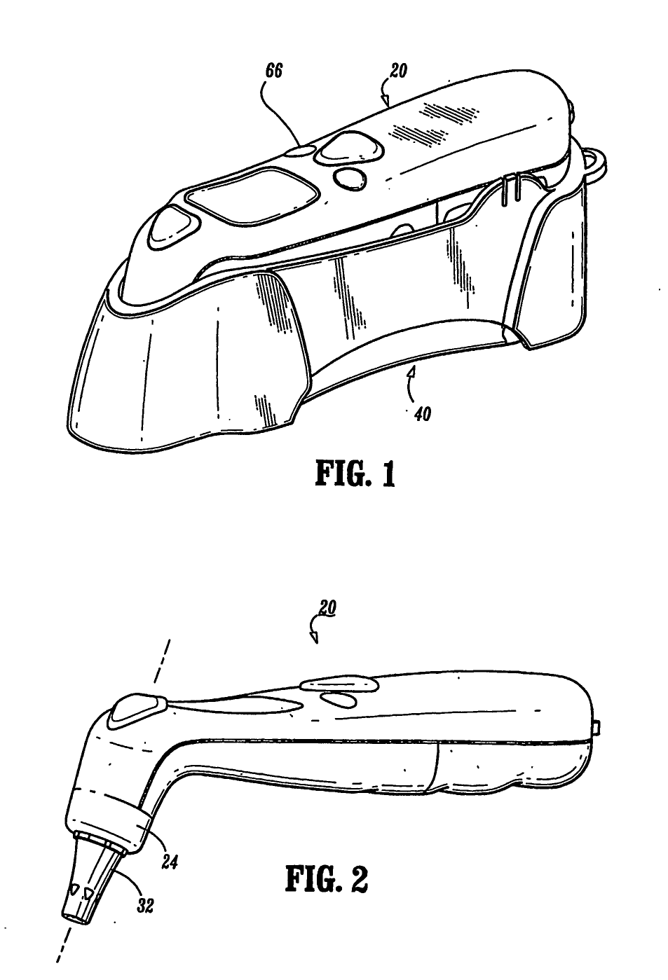

Reference will now be made in detail to the exemplary embodiments of the present disclosure, which are illustrated in the accompanying figures. Turning now to the figures wherein like components are designated by like reference numerals throughout the several views and initially to FIGS. 1 and 2, there is illustrated a tympanic thermometer 20, in accordance with the principles of the present disclosure.

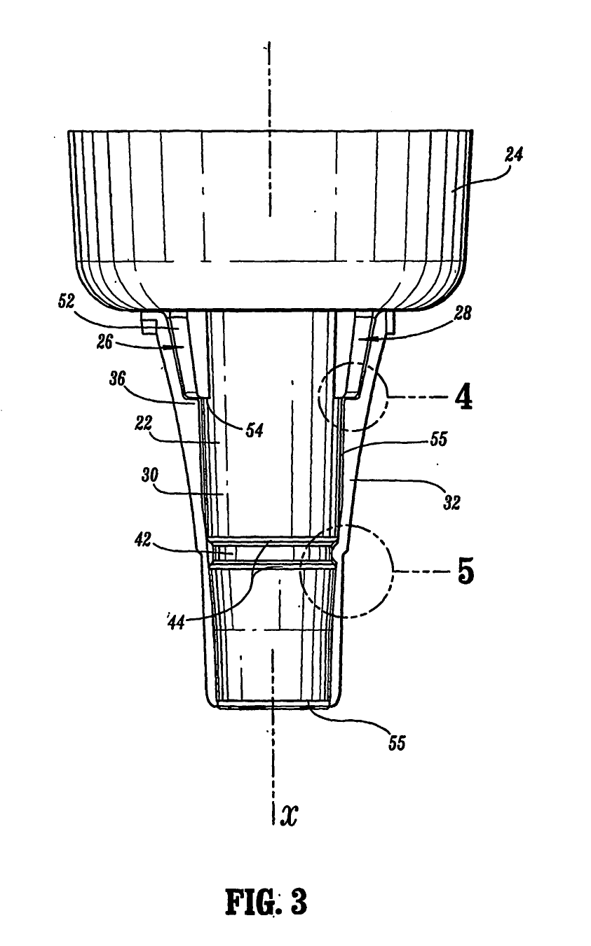

Tympanic thermometer 20 includes a cylindrical heat sensing probe 22 (FIG. 3). Heat sensing probe 22 extends from a distal end 24 of tympanic thermometer 20 and defines a longitudinal axis x. An ejection apparatus (FIG. 3) includes fingers 28 extending from distal end 24. Fingers 26 and 28 are configured for movement along an outer surface 30 of heat sensing probe 22. Heat sensing probe 22 may have various geometric cross-sectional configurations, such as, for example, rectangular, elliptical, etc.

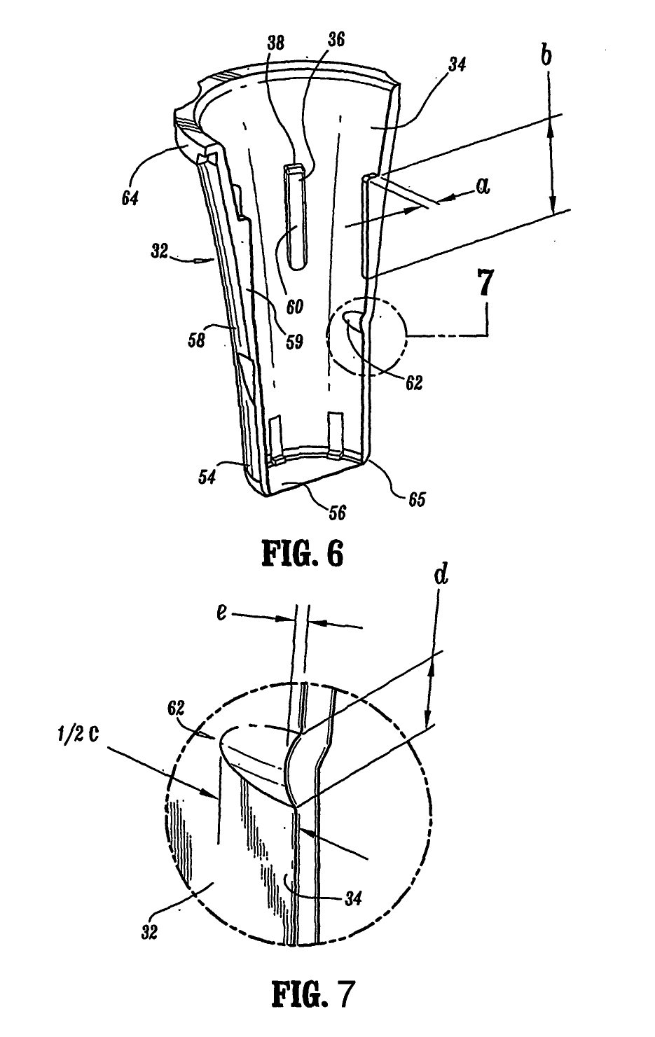

A probe cover 32 is mounted to distal end 24. Probe cover 32 defines an inner surface 34 FIG. 6) configured to engage outer surface 30. Probe cover 32 includes longitudinal ribs 36 (FIG. 6), as will be discussed, that radially project from inner surface 34. Longitudinal ribs 36 define a proximal strike face 38. Fingers 28 are configured to engage proximal strike face 38. It is envisioned that such engagement defines a zone of striking engagement or strike interface that advantageously facilitates removal of probe cover 32 from heat sensing probe 22 via ejection. This configuration improves temperature measurement accuracy and provides safety to minimize disease, bacteria, etc. propagation.

It is contemplated that tympanic thermometer 20 includes the necessary electronics and/or processing components to perform temperature measurement via the tympanic membrane, as is known to one skilled in the art. It is further envisioned that tympanic thermometer 20 may include a waveguide to facilitate sensing of the tympanic membrane heat energy. Tympanic thermometer 20 is releasably mounted in a holder 40 for storage in contemplation for use. Tympanic thermometer 20 and holder 40 may be fabricated from semi-rigid, rigid plastic and/or metal materials suitable for temperature measurement and related use. It is envisioned that holder 40 may include the electronics necessary to facilitate powering of tympanic thermometer 20, including, for example, battery charging capability, etc.

Heat sensing probe 22 defines a circumferential groove 42 in outer surface 30. Groove 42 is transversely oriented relative to longitudinal axis x such that it is substantially perpendicular thereto. Groove 42 is recessed within outer surface 30 to receive a portion of probe cover 32 for releasably retaining probe cover 32 with heat sensing probe 22, as will be discussed. Groove 42 has outer ends 44 that facilitate receipt and release of probe cover 32. Ends 44 may have varying degrees of curvature depending on the temperature measurement application. It is envisioned that groove 42 may extend about only a portion of the circumference of heat sensing probe 22. It is further envisioned that groove 42 may be oriented at various angular orientations relative to longitudinal axis x.

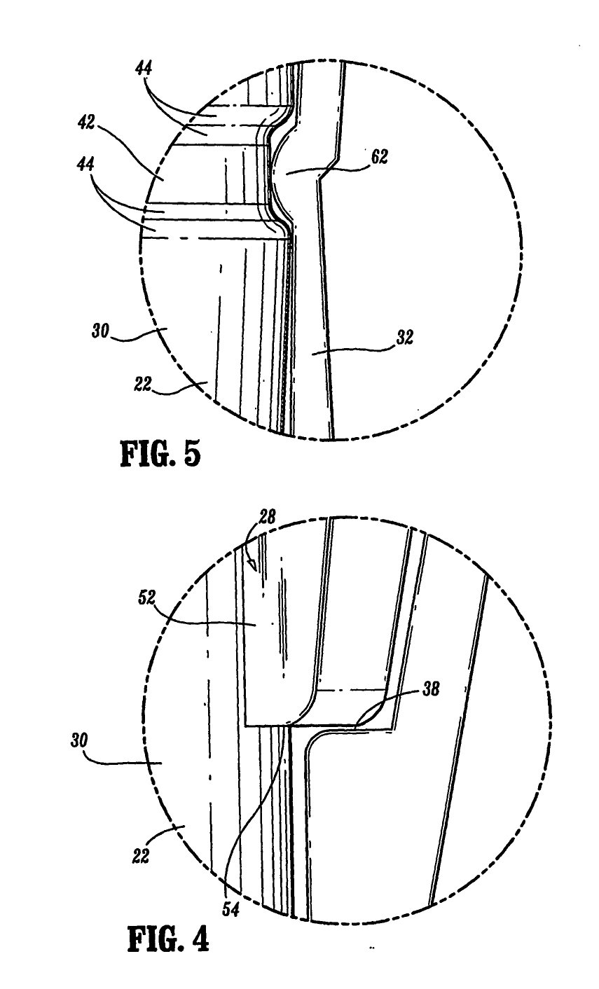

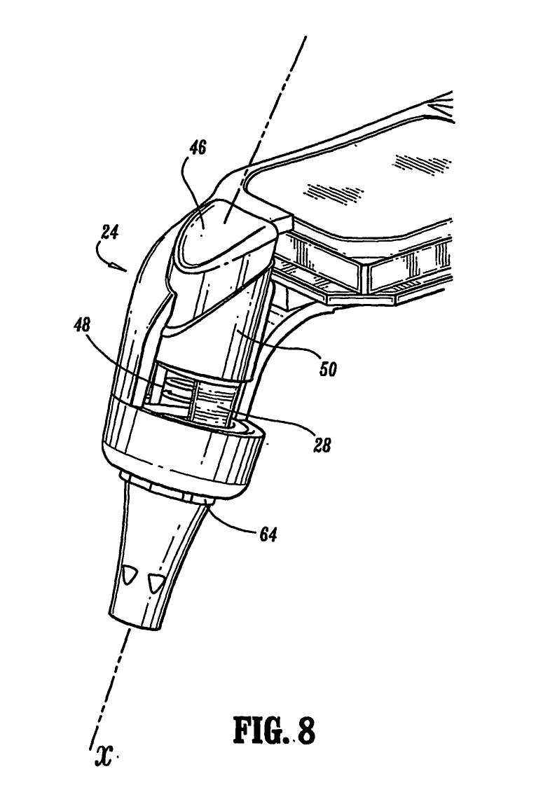

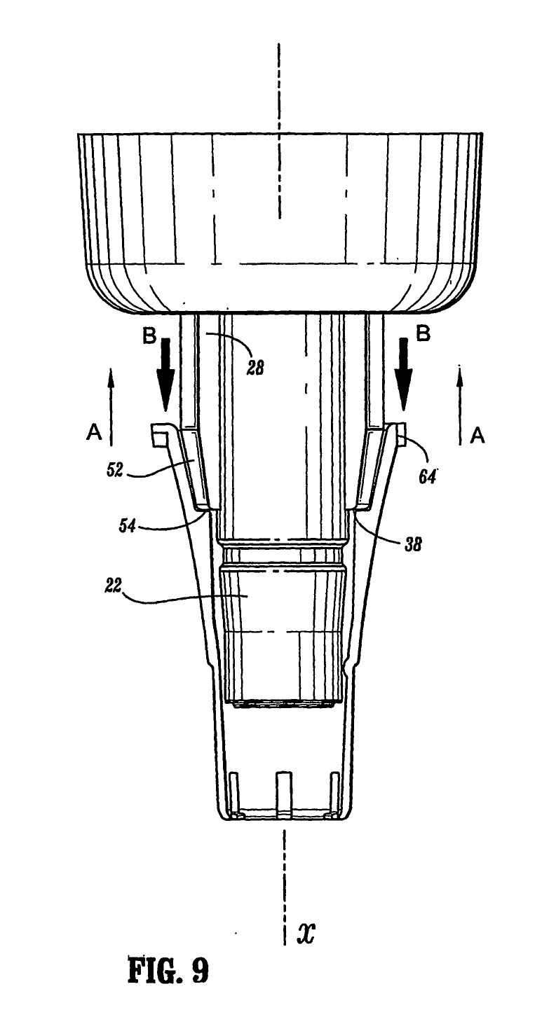

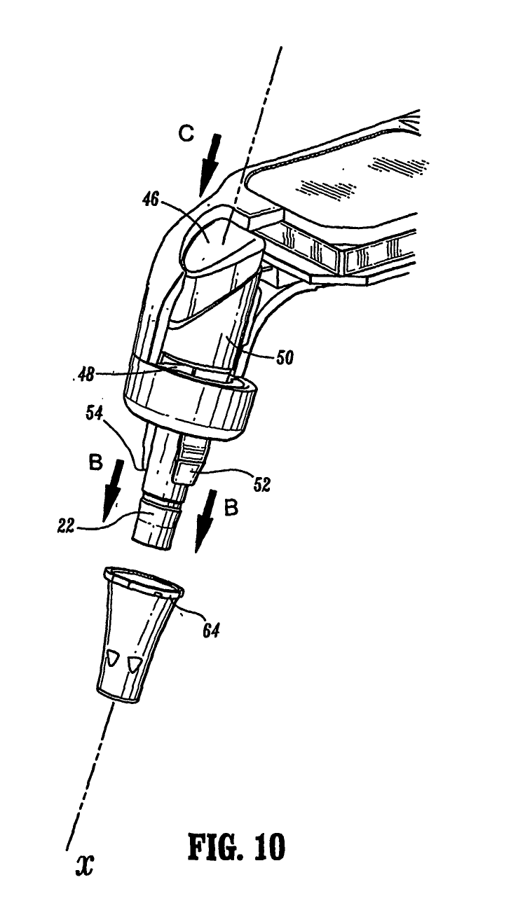

Referring to FIGS. 3-5 and 8, ejection apparatus 26 extends from distal end 24 of tympanic thermometer 20 and includes an eject button 46, compression spring 48 and ejection sleeve 50. Ejection sleeve 50 is mounted to distal end 24 such that fingers 28 extend distally therefrom and are disposed for movement about outer surface 30 of heat sensing probe 22. Fingers 28 and ejection sleeve 50 are in movable alignment with longitudinal axis x between a retracted position (FIG. 8) and an extended position (FIG. 10).

Compression spring 48 is mounted with ejection sleeve 50 such that fingers 28 are biased to the extended position. Compression spring 48 also provides resiliency to the motion of fingers 28. It is contemplated that compression spring 50 may have varying degrees of resilience according to the particular requirements of an ejection application.

Fingers 28 are releasably fixable in the retracted position via a latch (not shown). The latch includes eject button 46 that is engageable to release fingers 28 from the retracted position. Fingers 28 define a tapered fingertip 52 (FIG. 9) that extends to a distal strike face 54. The tapered surface of finger tip 52 facilitates a uniform and reliable engagement with surface 38 of probe cover 32. Finger tip 52 may have various degrees of taper or none at all.

Distal strike face 54 and proximal strike face 38 engage for moving fingers 28 between the retracted position and the extended position. Distal strike face 54 includes a planar surface disposed in a substantially perpendicular orientation relative to longitudinal axis x. The planar surface of distal strike face 54 facilitates uniform and reliable contact with proximal strike face 38 for ejection of probe cover 32 from heat sensing probe 22.

Upon mounting of probe cover 32 with heat sensing probe 22, proximal strike face 38 engages distal strike face 54 causing fingers 28 to slide along heat sensing probe 22, as shown by arrows A in FIG. 9. Probe cover 32 is properly seated with heat sensing probe 22 when ejection sleeve 50 locks into releasable engagement with the latch of ejection apparatus 26, in the retracted position. In the retracted position, ejection sleeve 50 interfaces with a switch or the like of tympanic thermometer 20. The switch activates and notifies tympanic thermometer 20 that an unused probe cover 32 is in the retracted position and ready to use for a temperature measurement application. Tympanic thermometer 20 includes the necessary electronics, circuitry and/or processing components to indicate position of fingers 28, ejection sleeve 50 and the used and unused status of probe cover 32. It is contemplated that probe cover 32 is particularly configured for engagement with ejection apparatus 26 and corresponding manipulation in the retracted position.

After a temperature measurement application is completed employing tympanic thermometer 20, eject button 46 is manipulated or otherwise activated to release ejection sleeve 50 from the retracted position. Compression spring 48 facilitates movement of fingers 28 and ejection sleeve 50 to the extended position via the spring forces thereof, as shown by arrows B in FIG. 9. Manipulation of eject button 48 in cooperation with the spring forces of compression spring 48 provide sufficient force such that engagement of distal strike face 54 with proximal strike force 38 causes probe cover 32 to eject from heat sensing probe 22. Movement of fingers 28 to the extended position deactivates the switch of tympanic thermometer 20. The switch notifies tympanic thermometer 20 that probe cover 32 is not in the retracted position and that probe cover 32 is not mounted with heat sensing probe 32. It is contemplated that tympanic thermometer 20 includes a display including illuminated icons, LED, etc. for indicating to a practitioner, for example, probe cover status, retracted position, extended position, etc. It is envisioned that in the extended position the display of tympanic thermometer 20 indicates to a practitioner that a new probe cover 32 is required for mounting with heat sensing probe 22.

Referring to FIGS. 6 and 7, probe cover 32, similar to the probe covers disclosed in co-pending and commonly assigned PCT Application No. PCT/US03/______, Express Mail Label No. EV222416147US, filed in the U.S. Patent and Trademark Office on Jan. 6, 2003 has a distal end 54 that is substantially enclosed by a film 56. Film 56 is substantially transparent to infrared radiation and configured to facilitate sensing of infrared emissions by heat sensing probe 22. Film 56 is advantageously impervious to ear wax, moisture and bacteria to prevent disease propagation.

The component portions of the probe cover, which is disposable, are fabricated from materials suitable for measuring body temperature via the tympanic membrane with a tympanic thermometer measuring apparatus. These materials may include, for example, plastic materials, such as, for example, polypropylene, polyethylene, etc., depending on the particular temperature measurement application and/or preference of a practitioner. The probe cover has a window portion or film that can be fabricated from a material substantially transparent to infrared radiation and impervious to moisture, ear wax, bacteria, etc. The film has a thickness in the range of 0.0005 to 0.001 inches, although other ranges are contemplated. The film may be semi-rigid or flexible, and can be monolithically formed with the remaining portion of the probe cover or integrally connected thereto via, for example, thermal welding, etc. One skilled in the art, however, will realize that other materials and fabrication methods suitable for assembly and manufacture, in accordance with the present disclosure, also would be appropriate.

A body 58 of probe cover 32 defines longitudinal ribs 36 projecting from inner circumferential surface 36 and being proximally spaced from distal end 54. Longitudinal ribs 36 project a thickness a and extend a length b along inner circumferential surface 34 providing increased strength to a wall 59 of probe cover 32. The increased strength of wall 59 facilitates ejection of probe cover 32 from heat sensing probe 22. Fingers 28 strike probe cover 32 for ejection from heat sensing probe 54. For example, longitudinal ribs 36 resist compressive forces created in body 58 as fingers 28 strike probe cover 32. This configuration prevents undesired failure of wall 59 facilitating manufacture of a thinner walled probe cover 32. Longitudinal ribs 36 define a transverse face 60 that is configured to engage heat-sensing probe 22. Thickness a, length b and transverse face 60 facilitate retention of probe cover 32 with heat sensing probe 22. Longitudinal ribs 36 also provide an air gap 55 (FIG. 3) of separation between heat sensing probe 22 and the tympanic membrane. This configuration minimizes undesirable heating of heat sensing probe 22 that may result in inaccurate temperature readings. It is contemplated that one or a plurality of longitudinal ribs 36 may be used, and that other similar projection fingers, bumps or detents could be used in order facilitate the engagement, interface, removal and/or ejection of probe cover 32 from heat sensing probe 22.

Body 58 defines inner protuberances 62 projecting from inner circumferential surface 34 and being proximally spaced from distal end 54. Inner protuberances 62 have an elliptical configuration including a width c (FIG. 7 shows ½ c due to the cross-section view) that is relatively larger than a height d. Inner protuberances 62 have a radial curvature projecting a thickness e from inner circumferential surface 34 for engaging heat sensing probe 22. Inner protuberances 62 facilitate retention of probe cover 20 with heat sensing probe 34. Inner protuberances 54 provide air gap 55 (FIG. 3) of separation between heat sensing probe 22 and the tympanic membrane. This configuration minimizes undesired heating of heat sensing probe 22. It is contemplated that one or a plurality of inner protuberances 62 may be used. Longitudinal ribs 36 and inner protuberances 62 may be variously dimensioned according to the particular requirements of a temperature measurement application.

Probe cover 32 includes a flange 64 disposed adjacent a proximal end 65 thereof Flange 64 is formed about the circumference of proximal end 65 providing strength and stability for mounting of probe cover 32 with tympanic thermometer 20.

Referring to FIGS. 8-10, probe covers 32, similar to that described, are fabricated, prepared for storage, shipment and use. Tympanic thermometer 20 is manipulated and removed from holder 40 by a practitioner. Heat sensing probe 22 of tympanic thermometer 20 is inserted within probe cover 32 for mounting therewith in contemplation for temperature measurement of a subject by the practitioner.

Inner surface 34 of probe cover 32 engages outer surface 30 of heat sensing probe 34 for retention therewith. Inner protuberances 62 slide over ends 44 and are positioned for disposal within groove 42. This configuration provides sufficient retention between heat sensing probe 34 and probe cover 32 so that probe cover 32 is retained with heat sensing probe 34 and probe cover 32 during temperature measurement of the subject. Thus, the retention strength of inner protuberances 62 with heat sensing probe 22 must be overcome for proper removal and ejection of probe cover 32 from heat sensing probe 22. It is contemplated that probe cover 32 may include other retention structure for mounting probe cover 32 with heat sensing probe 22, similar to those disclosed in co-pending and commonly assigned PCT Application No. PCT/US03/______ Express Mail Label No. EV222416147US, filed in the U.S. Patent and Trademark Office on Jan. 6, 2003.

As probe cover 32 is mounted to heat sensing probe 34, proximal strike face 38 of longitudinal ribs 36 engages distal strike face 54 of fingers 28 defining a zone for striking engagement to facilitate mounting and ejection of probe cover 32 from heat sensing probe 22. This configuration and method of use improve temperature measurement accuracy and provide safety to minimize disease, bacteria, etc. propagation.

As proximal strike face 38 engages distal strike face 54, in the direction shown by arrows A in FIG. 9, fingers 28 and ejection sleeve 50 are caused to slide along outer surface 30 of heat sensing probe 22. Ejection sleeve 50 engages the latch of ejection apparatus 26 to releasably lock fingers 28 in the retracted position (FIG. 8). Compression spring 48 provides a resilient ergonomic tactility to ejection apparatus 26 during mounting of probe cover 32 with heat sensing probe 22. Ejection sleeve 50 interfaces with a switch of tympanic thermometer 20. The switch activates tympanic thermometer 20 and notifies a practitioner, via a display thereof, that an unused probe cover 32 is in the retracted position and ready to use for temperature measurement.

In operation, to measure a subject's (not shown) body temperature, a practitioner (not shown) pulls the subject's ear back gently to straighten the ear canal so that heat sensing probe 22 can visualize the tympanic membrane for reading body temperature via infrared emissions. Tympanic thermometer 20 is manipulated by the practitioner such that a portion of probe cover 32, mounted to heat sensing probe 22, is easily and comfortably inserted within the subject's outer ear canal. Heat sensing probe 22 is properly positioned to sense infrared emissions from the tympanic membrane that reflect the subject's body temperature. Infrared light emitted from the tympanic membrane passes through film 56 and is directed to heat sensing probe 22.

The practitioner presses a button 66 (FIG. 1) of tympanic thermometer 20 for a sufficient period of time (typically 1-2 seconds) such that heat sensing probe 22 accurately senses infrared emissions from the tympanic membrane. Microelectronics of tympanic thermometer 20 process electronic signals provided by heat sensing probe 22 to determine the subject's body temperature. The microelectronics cause tympanic thermometer 20 to render body temperature measurement in a few seconds or less. Probe cover 32 is removed from heat sensing probe 22 and discarded.

Upon completion of satisfactory temperature measurement, the practitioner depresses eject button 46, as shown by arrow C in FIG. 10, to release ejection sleeve 50 and fingers 28 from the retracted position. Compression spring 48 facilitates movement of ejection sleeve 50 and fingers 28 to the extended position, as shown by arrows B in FIGS. 9 and 10. Distal strike face 54 engages proximal strike face 38 driving probe cover 32 in a distal direction. The strike force of distal strike face 54 is sufficient to overcome the retention force between protuberances 62 and outer ends 44 of groove 42. Thus, probe cover 32 is released from heat sensing probe 22 and is ejected therefrom for proper removal. It is contemplated that the strike force of distal strike face 54, as provided by ejection apparatus 26, is sufficient to overcome any retention structure of probe cover 32, according to the requirements of a particular temperature measurement application or the particular preferences of a practitioner.

Movement of ejection sleeve 50 from the retracted position deactivates the switch of tympanic thermometer 26. The deactivated switch causes tympanic thermometer 20 to notify the practitioner, via display, that ejection sleeve 50 is not in the retracted position and probe cover 20 is not ready for use until an unused probe cover 32 is mounted with heat sensing probe 22.

Tympanic thermometer 20 may be reused and another probe cover 32 may be mounted to heat sensing probe 22. Other methods of use of tympanic thermometer 20 are envisioned, such as, for example, alternative positioning, orientation, etc. It is contemplated that probe cover 32 is dedicated for use with tympanic thermometer 20.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A tympanic thermometer comprising:
a heat sensing probe defining a longitudinal axis and an outer surface extending from a distal end of the tympanic thermometer;
an ejection apparatus including at least one finger extending from the distal end of the tympanic thermometer and being configured for movement along the outer surface of the probe; and
a probe cover being mountable to the distal end of the tympanic thermometer, the probe cover defining an inner surface configured to engage the outer surface of the probe, the probe cover including at least one longitudinal rib radially projecting from the inner surface thereof, the longitudinal rib defining a proximal face to facilitate ejection of the probe cover,
wherein the at least one finger is configured to engage the proximal face.

2. A tympanic thermometer as recited in claim 1, wherein the outer surface of the probe defines a groove, transversely oriented relative to the longitudinal axis, which is configured to receive a portion of the probe cover for releasably retaining the probe cover with the probe.

3. A tympanic thermometer as recited in claim 2, wherein the portion of the probe cover includes a plurality of protuberances projecting from the inner surface of the probe cover and being proximally spaced from the distal end of the probe cover.

4. A tympanic thermometer as recited in claim 1, wherein the ejection apparatus includes a plurality of fingers.

5. A tympanic thermometer as recited in claim 1, wherein the at least one finger includes a tapered finger tip defining a distal strike face.

6. A tympanic thermometer as recited in claim 1, wherein the at least one finger is movable between a retracted position and an extended position.

7. A tympanic thermometer as recited in claim 6, whereby the at least one finger is biased to the extended position.

8. A tympanic thermometer as recited in claim 1, whereby the at least one finger is releasably fixable in a retracted position.

9. A tympanic thermometer as recited in claim 8, wherein the at least one finger is releasably fixable via a latch, whereby the latch includes a release button that is engageable to release the at least one finger from the retracted position.

10. A probe cover as recited in claim 1, wherein the probe cover includes a plurality of longitudinal ribs.

11. A tympanic thermometer as recited in claim 1, wherein the at least one longitudinal rib has a transverse face having a substantially parallel orientation relative to the longitudinal axis of the probe.

12. A tympanic thermometer as recited in claim 1, wherein the ejection apparatus includes equidistantly spaced fingers, each having a tapered finger tip that defines a distal strike face and the probe cover including equidistantly spaced longitudinal ribs, each having a proximal strike face, wherein the distal strike faces and proximal strike faces engage for moving the fingers between a retracted position and an extended position.

13. A tympanic thermometer comprising:
a heat sensing probe defining a longitudinal axis and an outer surface extending from a distal end of the tympanic thermometer, the probe defining a transverse groove in the outer surface;
an ejection apparatus including at least one finger extending from the distal end of the tympanic thermometer and being configured for movement along the outer surface of the probe, the at least one finger being disposed for movement proximal to the transverse groove; and
a probe cover having an inner surface being releasably mountable to the outer surface of the probe, the probe cover including at least one longitudinal rib projecting from the inner surface of the probe cover, the at least one longitudinal rib defining a proximal face configured for engagement with the at least one finger;
wherein the proximal face and the at least one finger engage for moving the at least one finger between a retracted position and an extended position.

14. A tympanic thermometer as recited in claim 13, wherein the transverse groove is disposed circumferentially about the outer surface of the probe and substantially perpendicular to the longitudinal axis of the probe.

15. A tympanic thermometer as recited in claim 13, wherein the at least one finger includes a tapered finger tip defining a distal strike face.

16. A tympanic thermometer as recited in claim 15, wherein the distal strike face is configured for engagement with the proximal face of the at least one longitudinal rib.

17. A tympanic thermometer as recited in claim 13, wherein the at least one finger is biased to the extended position.

18. A tympanic thermometer as recited in claim 13, wherein the at least one finger is releasably fixed in the retracted position.

19. A tympanic thermometer as recited in claim 18, wherein the at least one finger is releasably fixable via a latch, the latch including a release button being engageable to release the at least one finger from the retracted position.

20. A tympanic thermometer comprising:
a cylindrical heat sensing probe extending from a distal end of the tympanic thermometer and defining a longitudinal axis, the probe defining a circumferential groove in an outer surface thereof;
an ejection apparatus extending from the distal end of the tympanic thermometer and including a plurality of fingers disposed about the outer surface of the probe, the fingers being movable between a retracted position and an extended position whereby the fingers are biased to the extended position and releasably fixable in the retracted position via a latch, the latch including a release button that is engageable to release the fingers from the retracted position, the fingers defining a tapered finger tip that includes a distal strike face; and
a probe cover being releasably mountable to the probe, the probe cover including a plurality of protuberances projecting from an inner circumferential surface thereof and being proximally spaced from a distal end of the probe cover, the protuberances being receivable within the groove for releasably retaining the probe cover with the probe, the probe cover further including a plurality of longitudinal ribs radially extending from an inner circumferential surface of the probe cover, the longitudinal ribs defining a proximal strike face configured to engage the distal strike face of the fingers,
wherein the distal strike face and the proximal strike face engage for moving the fingers between the retracted position and the extended position.
